(19) United States
(12) Patent Application Publication
(10) Pub. No.: US 2025/0306221 A1
(43) Pub. Date: Oct. 2, 2025

(54) SEMICONDUCTOR DETECTOR

(71) Applicant: HITACHI HIGH-TECH ANALYSIS CORPORATION, Tokyo (JP)

(72) Inventor: Kazuyuki HOZAWA, Tokyo (JP)

(21) Appl. No.: 19/084,284

(22) Filed: Mar. 19, 2025

(30) Foreign Application Priority Data
Mar. 27, 2024 (JP) 2024-051413

(51) Int. Cl. G01T 1/24

(52) U.S. Cl. CPC G01T 1/241

(57) ABSTRACT

Proposed is a semiconductor detector that can improve CPS by reducing a rise time by being operated with higher bias. The semiconductor detector includes a semiconductor substrate, a first surface-side insulating film, a signal detection electrode, a plurality of drift electrodes, an incident window 5 for radiation, a p-type semiconductor region, depletion electrodes, a plurality of field plate electrodes, charge collection electrodes disposed in inter-electrode regions between adjacent drift electrodes; a plurality of drift electrode connection portions electrically connecting some of the plurality of drift electrodes and the field plate electrodes, and connection wires electrically connecting the drift electrodes not connected to the field plate electrodes by the drift electrode connection portions and the charge collection electrodes through collection electrode connection portions.

### CROSS REFERENCE TO RELATED APPLICATION

The present application claims priority to Japanese Patent Application No. JP2024-51413 filed Mar. 27, 2024, the entire contents of which are incorporated herein for all purposes by this reference.

### BACKGROUND

### Technical Field

The present disclosure relates to a semiconductor detector that can detect electromagnetic waves and radiation.

### Description of the Related Art

A Silicon Drift Detector (hereafter, referred to as an SDD) is used as a semiconductor detector for electromagnetic waves such as X-ray or electron beams that are applied to X-ray fluorescence (XRF) products that detect fluorescent X-rays, Energy-Dispersive X-ray analysis (SEM-EDS) products, and synchrotron X-ray detectors.

An SDD is a semiconductor detector that measures the energy and quantity of electromagnetic waves on the basis of the amount of charges collected by moving charge carriers generated by electromagnetic waves traveling in a depletion layer, to which a drift electric field is applied, to a signal detection electrode through the drift electric field.

That is, in an SDD, a depletion layer is expanded throughout the entire semiconductor substrate by applying a reverse bias voltage to a pn junction formed on the semiconductor substrate, and in this state, charge carriers generated by electromagnetic waves traveling in the depletion layer are moved to a signal detection electrode through the drift electric field. Further, the energy and quantity of electromagnetic waves are measured on the basis of the amount of charges collected at the signal detection electrode.

The SDD is often used in fluorescence X-ray analysis devices due to its high resolution in a wide range from low energy of several tens of eV to high energy of several tens of KeV, as well as its ability to use a Peltier element for cooling instead of liquid nitrogen.

Further, one of the great merits of the SDD may be that, due to the very small size of a signal detection electrode, the capacitance (parasitic capacitance) of the signal detection electrode can be suppressed at a low level regardless of the signal detection area.

Because of this merit, the SDD reduces noise caused by parasitic capacitance, so low-energy electromagnetic waves can be measured.

Further, when the performance of the SDD is further improved and a large number of electromagnetic waves can be detected in a short time, the range of applications for the SDD expands, so the value of the SDD can be increased.

For example, a field-plate type SDD semiconductor detector 100 of the related art, as shown in FIG. 5 to FIG. 8, includes: a semiconductor substrate 2; a signal detection electrode 3 formed on a first surface (one side) of the semiconductor substrate 2; a plurality of drift electrodes 4 formed on the first surface of the semiconductor substrate 2 to surround the signal detection electrode 3 and to move carriers toward the signal detection electrode 3; field plate electrodes 113 formed on the first surface of the semiconductor substrate 2 to suppress electrical current flowing between the drift electrodes 4; drift connection portions 10a connecting the drift electrodes 4 and the field plate electrodes 113; and a detection electrode connection portion 10b connecting the signal detection electrode 3 and a signal detection pad 12.

The field plate electrode 113 is an electrode installed to reduce noise (dark current or leak current) generated between the drift electrodes 4 and a bias is applied so that it has a higher potential than the adjacent drift electrodes 4, thereby serving to suppress depletion of the first surface-side insulating film 10 and an SiO₂/Si interface 20 of the semiconductor substrate 2.

For example, in Patent Document 1, a semiconductor device having first and second conductive plates (FFP) 14 and 19, which are field plate electrodes, has been disclosed as such a field plate type.

### RELATED ART DOCUMENT

(Patent Document) WO2019/202760

### SUMMARY

The following problems remain in the related art described above.

As representative indexes showing the performance of an SDD, Full Width at Half Maximum (FWHM) and Counts Per Second (CPS) have been known. The smaller the value of the FWHM, the higher the resolution of a detected signal, and the larger the value of the CPS, the more signals can be detected per unit time. As a representative technique that improves the CPS, it is effective is to reduce a rise time of a signal. The rise time increases as a charge carrier cloud (electron cloud) generated by incident electromagnetic waves spreads widely while moving toward the center from the outer part of an SDD. Accordingly, a small detection area of an SDD is advantageous for reduction of the rise time, but when the area is large, the total count number correspondingly decreases, so it is possible to know that it is difficult to increase the CPS while maintaining a short rise time.

Meanwhile, as shown in FIG. 5, it is known that when the bias applied to an outer electrode RX among the biases that are applied to operate an SDD (an inner electrode R1 that is center ring electrode of a ring side, the outer electrode RX that is an outer ring electrode, and a depletion electrode BC that is a back contact electrode of a window side) is increased, the rise time is reduced. This is because the electric fields between the inner electrode R1 and the outer electrode RX and between the outer electrode RX and the depletion electrode BC intensify, and this result represents that there is a possibility of reduction of the rise time due to an increase of the operation voltage of the SDD. However, application of three types of biases for the inner electrode R1, the outer electrode RX, and the depletion electrode BC is required to operate the SDD and these three types of biases are interrelated, and when a high voltage is applied to only any one of them, optimal SDD characteristics cannot be achieved. For example, it has been known that it is difficult to obtain a bias condition allowing reduction of a rise time with an optimal FWHM maintained.

The present disclosure has been made in consideration of the issues described above and an objective of the present disclosure is to provide a semiconductor detector that can improve CPS by reducing a rise time through higher bias operation.

The present disclosure employs the following configuration to achieve the objectives described above. That is, a semiconductor detector according to a first aspect of the present disclosure includes: an n-type semiconductor substrate; a first surface-side insulating film formed on a first surface of the semiconductor substrate; a signal detection electrode formed on the first surface and configured to collect charges generated by incidence of radiation; a plurality of drift electrodes formed on the first surface to surround the signal detection electrode and configured to move the charges toward the signal detection electrode when a voltage is applied to generate a potential gradient with potential changing toward the signal detection electrode; an incident window for radiation installed on a second surface of the semiconductor substrate; a p-type semiconductor region formed on a surface of the incidence window that faces the second surface; depletion electrodes formed on the second surface and configured to apply reverse bias between the p-type semiconductor region and an n-type semiconductor region inside the semiconductor; a plurality of field plate electrodes 13 formed on an outer surface opposite inter-electrode regions between drift electrodes that are adjacent to suppress electrical current flowing between the drift electrodes; charge collection electrodes disposed in the inter-electrode regions between the drift electrodes that are adjacent; a plurality of drift electrode connection portions formed through the first surface-side insulating film and configured to electrically connect some of the plurality of drift electrodes and the field plate electrodes; and connection wires formed on the outer surface and configured to electrically connect the drift electrodes not connected to the field plate electrodes by the drift electrode connection portions with the charge collection electrodes through collection electrode connection portions formed through the first surface-side insulating film.

Since the semiconductor detector includes the connection wires electrically connecting the drift electrodes not connected to the field plate electrodes by the drift electrode connection portions with the charge collection electrodes through collection electrode connection portions formed through the first surface-side insulating film, a dark current between adjacent drift electrodes is drawn through the charge collection electrodes and the connection wires, whereby it is possible to suppress a leak current between the drift electrodes. Accordingly, it is possible to set higher optimal bias by suppressing a leak current between the drift electrodes 4, so it is possible to reduce a rise time.

In a semiconductor detector according to a second aspect, at least one of the plurality of field plate electrodes is disposed opposite the inter-electrode regions to cover the inter-electrode regions between three or more drift electrodes in the first aspect.

That is, in this semiconductor detector, since at least one of the plurality of field plate electrodes is disposed opposite the inter-electrode regions to cover the portions the inter-electrode regions between three or more drift electrodes, it is possible to apply higher bias to the portions between farther drift electrodes. In this way, the width of wires (ladders) connecting the drift electrodes is adjusted by generating a higher potential difference between farther drift electrodes, whereby it is possible to control the potential generated between the drift electrodes by controlling voltage distribution between the drift electrodes.

In a semiconductor detector according to a third aspect, the plurality of charge collection electrodes is installed in different inter-electrode regions and connected to one of the drift electrodes through the collection electrode connection portion and the connection wire in the first or second aspect.

That is, in this semiconductor detector, since the plurality of charge collection electrodes is installed in different inter-electrode regions and is connected to one of the drift electrodes through the collection electrode connection portions and the connection wires, it is possible to more efficiently collect charges.

The present disclosure has the following effects.

Since the semiconductor detector includes the connection wires electrically connecting the drift electrodes not connected to the field plate electrodes by the drift electrode connection portions with the charge collection electrodes through collection electrode connection portions formed through the first surface-side insulating film, a dark current between adjacent drift electrodes is drawn through the charge collection electrodes and the connection wires, whereby it is possible to suppress a leak current between the drift electrodes.

Therefore, it is possible to set higher optimal bias in the semiconductor detector of the present disclosure, so it is possible to reduce the rise time and improve CPS.

### BRIEF DESCRIPTION OF THE DRAWINGS

FIG. 1 is a schematic cross-sectional view showing a semiconductor detector in an embodiment of a semiconductor detector according to the present disclosure;

FIG. 2 is a schematic cross-sectional view of main parts of the semiconductor detector in the embodiment;

FIG. 3 is a view of a first surface that shows a drift electrode, etc. in the embodiment;

FIG. 4 is a view of an outer surface of a first surface side-insulating film that shows a field plate electrode, etc. in the embodiment;

FIG. 5 is a schematic cross-sectional view showing a semiconductor detector in an example of the related art of a semiconductor detector according to the present disclosure;

FIG. 6 is a schematic cross-sectional view of main parts of the semiconductor detector in the example of the related art;

FIG. 7 is a view of a first surface that shows a drift electrode, etc. in the example of the related art; and

FIG. 8 is a view of an outer surface of a first surface side-insulating film that shows a field plate electrode, etc. in the example of the related art.

### DETAILED DESCRIPTION

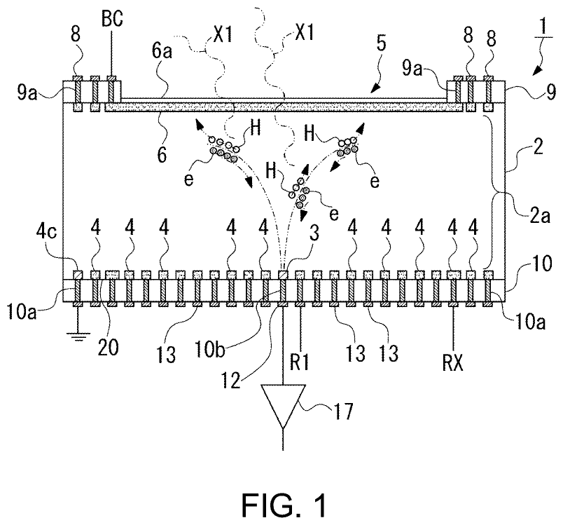

Hereafter, an embodiment of a semiconductor detector according to the present disclosure is described with reference to FIG. 1 to FIG. 4. Meanwhile, the drawings to be described hereafter have been rescaled, where necessary, to ensure that the components are recognizable or easily recognizable.

A semiconductor detector 1 according to the embodiment is a silicon drift detector (SDD) and, as shown in FIG. 1 to FIG. 4, includes: an n-type semiconductor substrate 2; a first surface-side insulating film 10 formed on a first surface (the underside in FIG. 1) of the semiconductor substrate 2; a signal detection electrode 3 formed on the first surface and collecting charges generated by incidence of radiation X1; a plurality of drift electrodes 4 formed on the first surface to surround the signal detection electrode 3 and moving charges toward the signal detection electrode 3 when a voltage is applied to generate a potential gradient with potential changing toward the signal detection electrode 3; an incident window 5 for radiation X1 installed on a second surface (the topside in FIG. 1) of the semiconductor substrate 2; a p-type semiconductor region 6 formed on a surface of the incidence window 5 that faces the second surface; depletion electrodes BC formed on the second surface and applying reverse bias between the p-type semiconductor region 6 and an n-type semiconductor region 2a inside the semiconductor 2; a signal detection pad 12 formed on the outer surface of the first surface-side insulating film 10 and facing the signal detection electrode 3; and a plurality of field plate electrodes 13 formed on the outer surface of the first surface-side insulating film 10 in a ring shape surrounding the signal detection pad 12 and formed oppositely between adjacent drift electrodes 4 to suppress electrical current flowing between the drift electrodes 4.

Further, the semiconductor detector 1 of the embodiment includes: charge collection electrodes 14 disposed in inter-electrode regions 4a between adjacent drift electrodes 4; a detection electrode connection portion 10b formed through the first surface-side insulating film 10 and electrically connecting the signal detection electrode 3 and the signal detection pad 12; a plurality of drift electrode connection portions 10a formed through the first surface-side insulating film 10 and electrically connecting some of the plurality of drift electrodes 4 and the field plate electrodes 13; and connection wires 15 formed on the outer surface and electrically connecting the drift electrodes 4 not connected to the field plate electrodes 13 by the drift electrode connection portions 10a with the charge collection electrodes 14 through collection electrode connection portions 10c formed through the first surface-side insulating film 10.

At least one of the plurality of field plate electrodes 13 is disposed opposite inter-electrode regions to cover the inter-electrode regions between three or more drift electrodes 4.

Further, the plurality of charge collection electrodes 14 is formed on the first surface, installed in different inter-electrode regions 4a, and connected to one drift electrode 14 through the collection electrode connection portion 10c and the connection wire 15.

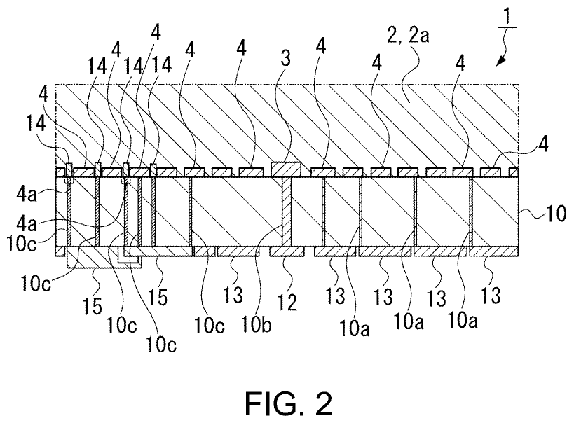

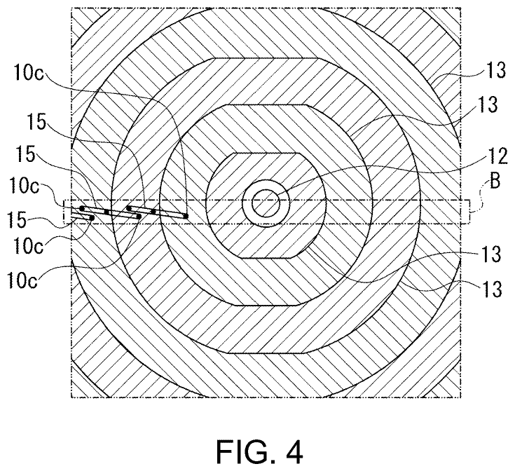

That is, each of the connection wires 15 of the embodiment, as shown in FIG. 2 and FIG. 4, connects two charge collection electrodes 14 installed in different inter-electrode regions 4a to one of the drift electrodes 14 through three collection electrode connection portions 10c.

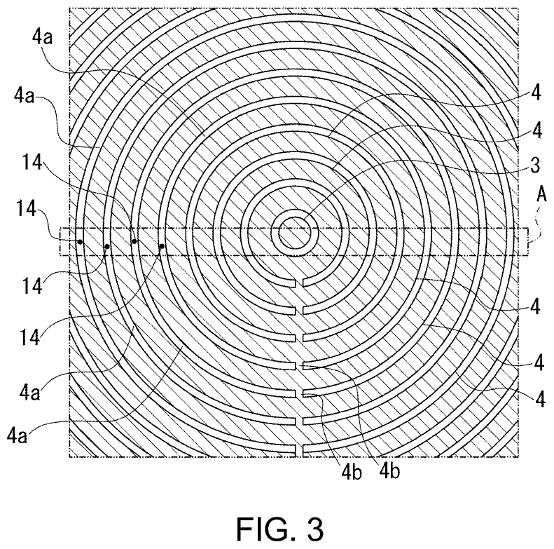

Meanwhile, FIG. 2 is a schematic cross-sectional view showing the regions surrounded by the phantom line (two-point dashed line) A in FIG. 3 and the phantom line (two-point dashed line) B in FIG. 4.

The semiconductor substrate 2, which is an Si substrate doped with n-type dopants, is a high-resistance substrate over 5 kΩ.

The signal detection electrode 3 is a signal output electrode made of an n⁺-type semiconductor and functions as an anode electrode.

An amplifier 17 is electrically connected to the signal detection electrode 3.

The amplifier 17 is formed with, for example, a field-effect transistor or a CMOS amplifier, and the gate electrode thereof is connected to the signal detection electrode 3.

The p-type semiconductor region 6 is a P⁺Si region in which boron (B) and fluorine (F) are both implanted and added, and a pn junction is formed between the -type semiconductor region 6 and the n-type semiconductor region 2a of the semiconductor substrate 2.

The p-type semiconductor region 6 functions as a cathode and the signal detection electrode 3 functions as an anode.

Meanwhile, an oxide film (SiO₂) 6a is formed on the surface of the p-type semiconductor region 6.

The depletion electrode BC is a back contact connected to the p-type semiconductor region 6 and a voltage that is applied to the depletion electrode BC is adjusted, whereby reverse bias is applied to the pn junction and a depletion layer expands from the pn junction, and accordingly, the semiconductor substrate 2 is depleted.

Further, a plurality of ring-shaped protective electrodes 8 set to a floating potential is formed outside around the depletion electrode BC to prevent dielectric breakdown between the edge of the semiconductor substrate 2 and the p-type semiconductor region 6.

The plurality of drift electrodes 4 are coaxial ring electrodes having the signal detection electrode 3 as a center and are formed with gaps therebetween. Meanwhile, the adjacent drift electrodes 4 are connected to each other by connection portions 4b very narrower than the width of the drift electrodes 4.

The plurality of drift electrodes 4 has an inner electrode R1 formed on the inner circumference and an outer electrode Rx formed on the outer circumference. Meanwhile, different voltages are applied to the inner electrode R1 and the outer electrode RX, whereby a drift electric field is generated in the semiconductor substrate 2 having a depletion layer.

That is, voltages are applied such that the potential of the innermost drift electrode 4 is the highest and the potential of the outermost drift electrode 4 is the lowest.

Further, the outermost electrode 4c is a grounding electrode.

The first surface is a surface on which the plurality of ring-shaped drift electrodes 4 is formed, that is, a ring surface.

Further, the second surface is a surface on which the incidence window 5 is formed, that is, a window surface.

A second surface-side insulating film 9 of oxide film (SiO₂) is formed as a guard ring around the incidence window 5.

The protective electrode 8 and the depletion electrode BC are each connected with the semiconductor substrate 2 or the p-type semiconductor region 6 through a metal electrode 9a of Al, etc. formed through the second surface-side insulating film 9.

The first surface-side insulating film 10 is an oxide film (SiO₂) formed on the first surface.

The signal detection electrode 3 and the plurality of drift electrodes 4 are each connected to the n-type semiconductor region 2a of the semiconductor substrate 2 by the drift electrode connection portion 10a and the detection electrode connection portion 10b formed through the first surface-side insulating film 10.

The detection electrode connection portion 10b, the drift electrode connection portion 10a, and the collection electrode connection portion 10c are metal electrodes of Al, etc. formed through the first surface-side insulating film 10.

Further, Ti or Poli-Si may also be used for the metal electrode in addition to Al, and elements that are as light as possible and have low resistance are preferred.

The drift electrodes 4 are formed by implanting boron (B) and aluminum (Al).

Further, the charge collection electrode 14 and the signal detection electrode 3 are formed by implanting phosphorous (P) or arsenic (As).

The signal detection pad 12 and the field plate electrodes 13 are patterned using aluminum (Al).

A plurality of connection wires 15 is installed on the field plate electrode 13, as shown in FIG. 3.

Further, the drift electrodes 4 connected to the connection wires 15 through the collection electrode connection portions 10c, as described above, are not connected with the field plate electrode 13 through the drift electrode connection portions 10a.

The plurality of field plate electrodes 13 are coaxial ring electrodes having the signal detection electrode 12 as a center and are formed with gaps therebetween.

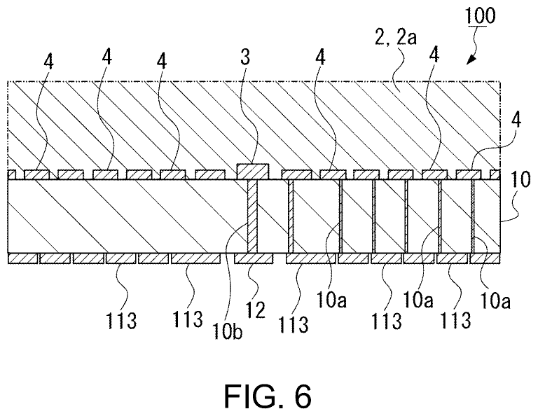

Further, SDDs of the related art have a structure in which, as shown in FIG. 6, the field plate electrode 113 covers only the inter-electrode regions between two adjacent drift electrodes 4, but the field plate electrode 13 of the SDD (semiconductor detector 1) of the embodiment covers a drift electrode 4 at a side in addition to the inter-electrode regions between two adjacent drift electrodes 4. That is, the field plate electrodes 13 are disposed opposite the inter-electrode regions cover the inter-electrode regions between three drift electrodes 4.

The semiconductor detector 1 of the embodiment is operated as follows.

First, when radiation X1, such as X-rays, photons, electron beams, or other charged particles, enters the semiconductor substrate 2 from the incidence window 5, charges (holes H and electrons e) are generated inside the semiconductor substrate 2 according to the energy of the radiation X1 absorbed in the semiconductor substrate 2.

These charges is moved by an electric field in the semiconductor substrate 2, and the electrons e flow into the signal detection electrode at the center and are collected. The electrons e collected at the signal detection electrode 3 are output as an electrical signal through the amplifier 17.

Further, a dark current or a leak current generated between adjacent drift electrodes 4 is drawn to the connection wires 15 through the collection electrode connection portions 10c from the charge collection electrodes 14 disposed in the inter-electrode regions 4a.

As described above, since the semiconductor detector 1 according to the embodiment includes the connection wires 15 electrically connecting the drift electrodes 4 not connected to the field plate electrode 13 by the drift electrode connection portions 10a with the charge collection electrodes 14 through the collection electrode connection portions 10c formed through the first surface-side insulating film 10, a dark current between adjacent drift electrodes 4 (in the inter-electrode regions 4a) is drawn through the charge collection electrodes 14 and the connection wires 15, whereby it is possible to suppress a leak current between the drift electrodes 4. Accordingly, it is possible to set higher optimal bias by suppressing a leak current between the drift electrodes 4, so it is possible to reduce a rise time.

Further, since at least one of the plurality of field plate electrodes 13 is disposed opposite inter-electrode regions to cover the inter-electrode regions between three or more drift electrodes 4, it is possible to apply higher bias to the portions between farther drift electrodes 4. In this way, the width of wires (ladders) connecting the drift electrodes 4 is adjusted by generating a higher potential difference between farther drift electrodes 4, whereby it is possible to control the potential generated between the drift electrodes 4 by controlling voltage distribution between the drift electrodes 4.

Further, since the plurality of charge collection electrodes 14 is installed in different inter-electrode regions 4a and is connected to one of the drift electrodes 4 through the collection electrode connection portions 10c and the connection wires 15, it is possible to more efficiently collect charges.

### Embodiment

As an embodiment of the present disclosure, the results of measuring the FWHM and the rise time when changing the voltage between BC-R1 and the voltage between RX-R1 in the SDD (semiconductor detector) of the above embodiment are shown in Table 1 and Table 2.

Meanwhile, the measurement result for an SDD (semiconductor detector) with a large area is shown in Table 1 and the measurement result for an SDD (semiconductor detector) with a small area is shown in Table 2.

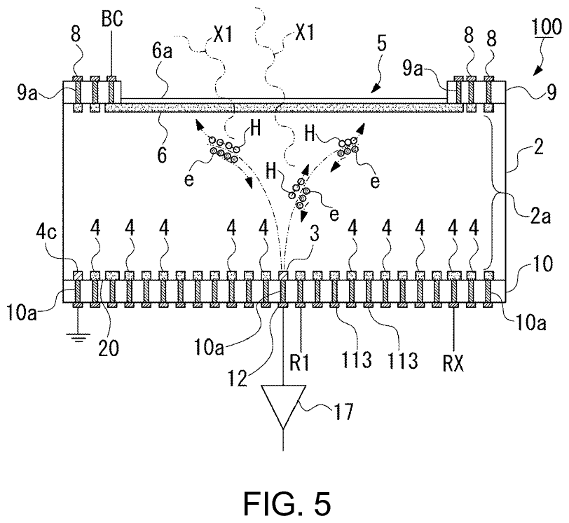

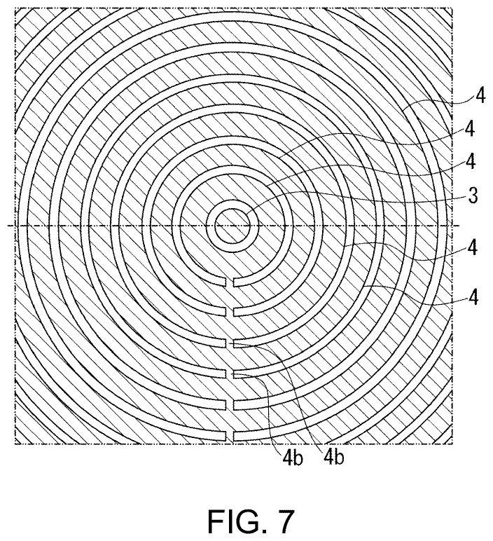

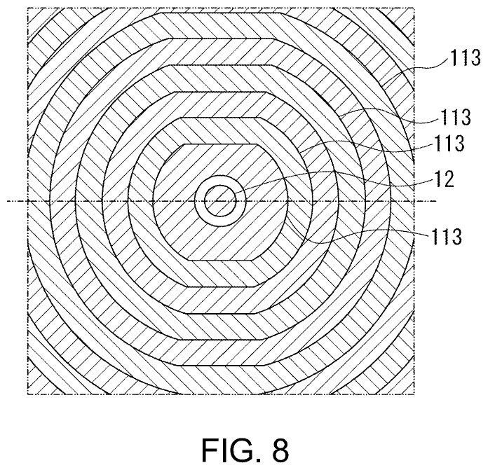

Further, as an example related to the related art, the same measurements for the SDD of the related art shown in FIG. 5 to FIG. 8 are also shown in Table 1 and Table 2.

It can be seen from the results that the rise time was reduced in the present disclosure in comparison to the related art.

TABLE 1

| | BC-R1 | RX-R1 | FWHM | Rise time |
|---|---|---|---|---|
| | (V) | (V) | (eV) | (ns) |
| Related art | 70 | 115 | 127 | 102 |
| Invention 1 | 90 | 145 | 128 | 90 |
| Invention 2 | 110 | 145 | 129 | 57 |
| Invention 3 | 130 | 145 | 127 | 39 |

TABLE 2

| | BC-R1 | RX-R1 | FWHM | Rise time |
|---|---|---|---|---|
| | (V) | (V) | (eV) | (ns) |
| Related art 1 | 45 | 60 | 134 | 72 |
| Related art 2 | 45 | 65 | 133 | 68 |
| Related art 3 | 45 | 70 | 132 | 61 |
| Invention 1 | 95 | 110 | 126 | 33 |
| Invention 2 | 90 | 125 | 126 | 32 |
| Invention 3 | 95 | 120 | 125 | 28 |

Meanwhile, the scope of the present disclosure is not limited to the examples and embodiments described above and the present disclosure may be changed in various ways without departing from the spirit of the present disclosure.

What is claimed is:

1. A semiconductor detector comprising:
an n-type semiconductor substrate;
a first surface-side insulating film formed on a first surface of the semiconductor substrate;
a signal detection electrode formed on the first surface and configured to collect charges generated by incidence of radiation;
a plurality of drift electrodes formed on the first surface to surround the signal detection electrode and configured to move the charges toward the signal detection electrode when a voltage is applied to generate a potential gradient with a potential changing toward the signal detection electrode;
an incident window for radiation installed on a second surface of the semiconductor substrate;
a p-type semiconductor region formed on a surface of the incidence window that faces the second surface;
depletion electrodes formed on the second surface and configured to apply reverse bias between the p-type semiconductor region and an n-type semiconductor region inside the semiconductor;
a plurality of field plate electrodes formed on an outer surface of the first surface-side insulating film opposite inter-electrode regions between the drift electrodes that are adjacent to suppress electrical current flowing between the drift electrodes;
charge collection electrodes disposed in the inter-electrode regions between the drift electrodes that are adjacent;
a plurality of drift electrode connection portions formed through the first surface-side insulating film and configured to electrically connect some of the plurality of drift electrodes and the field plate electrodes; and
connection wires formed on the outer surface and configured to electrically connect the drift electrodes not connected to the field plate electrodes by the drift electrode connection portions with the charge collection electrodes through collection electrode connection portions formed through the first surface-side insulating film.

2. The semiconductor substrate of claim 1, wherein at least one of the plurality of field plate electrodes is disposed opposite the inter-electrode regions to cover the inter-electrode regions between three or more drift electrodes.

3. The semiconductor substrate of claim 1, wherein the plurality of charge collection electrodes is installed in different inter-electrode regions and connected to one of the drift electrodes through the collection electrode connection portion and the connection wire.

4. The semiconductor substrate of claim 2, wherein the plurality of charge collection electrodes is installed in different inter-electrode regions and connected to one of the drift electrodes through the collection electrode connection portion and the connection wire.
